(19) United States
(12) Patent Application Publication
(10) Pub. No.: US 2005/0013650 A1
(43) Pub. Date: Jan. 20, 2005

(54) Device and method for applying a solid substance that can be applied by the action of heat

(76) Inventors: Wolfgang Klauck, Meerbusch (DE); Rainer Dahm, Mettmann (DE)

Correspondence Address: HENKEL CORPORATION, THE TRIAD, SUITE 200, 2200 RENAISSANCE BLVD., GULPH MILLS, PA, 19406, US

(21) Appl. No.: 10/796,807

(22) Filed: Mar. 9, 2004

Related U.S. Application Data
(63) Continuation of application No. PCT/EP02/08746, filed on Aug. 6, 2002.

(30) Foreign Application Priority Data
Aug. 8, 2001 (DE) 101 38 862.4

(51) Int. Cl. B43K 23/00; B43M 1/02

(52) U.S. Cl. 401/88; 156/73.5; 427/11; 427/207.1; 427/208.2; 401/1

(57) ABSTRACT

A device for applying a meltable substance, particularly a hot melt adhesive, to a substrate. The device imparts a rotating or vibrating motion to the substance to generate mechanical friction between the meltable substance and the substrate, causing the substrate to melt and apply to the substrate.

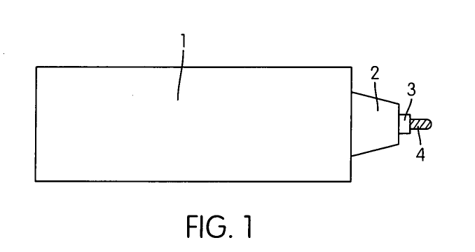

This invention relates to a device and a method for applying a solid substance capable of application by heating, more particularly a hotmelt adhesive, to a substrate, said device comprising a housing with a holder for the solid substance that is open to the outside.

There are various known devices for applying solid thermoplastic adhesives or the like (for example low-melt or hot-melt adhesives) to substrates. So-called adhesive guns, of which there are many known types, are frequently used. Such devices comprise a holder for the hotmelt adhesive inside the housing, the hotmelt adhesive being loaded into the device in the form of a solid rod or stick. At least the front dispensing section of the device which surrounds the hotmelt adhesive is equipped with a heating system by which the hotmelt adhesive is heated before use to its melting temperature (60 to 80° C. for low-melt adhesives or 180 to 220° C. for hotmelt adhesives) and can then be applied to the substrate in molten form. Besides these conventional hotmelt adhesive guns, there are also devices with a heating system which enable the molten adhesive to be sprayed.

However, one feature common to all these known devices is that they require a heating system by which the adhesive can at least be melted or even liquefied so that it can be subsequently applied or sprayed. Such heating systems on the one hand are complicated and require considerable heating energy and, on the other hand, can only function after a certain heating period, i.e. only when a sufficient quantity of hotmelt adhesive has been melted.

The object of the present invention was to provide a solution by which a solid substance of the type in question, more particularly a hotmelt adhesive, could be applied in simple fashion to a substrate without requiring much energy; the adhesive would be available for application immediately, i.e. without a long preparation time.

According to the invention, the solution to the problem of generating external friction is provided by a device of the type mentioned at the beginning which is characterized in that the holder for the solid substance is connected to a rotatable and/or vibratable element located in the housing.

Accordingly, in contrast to known devices of the type in question, the device according to the invention does not have a heating system so that neither heating energy nor long heating times are required. Instead, the device according to the invention is immediately ready for processing or applying hotmelt adhesives or the like. When the device is actuated, the holder for the hotmelt adhesive and hence the hotmelt adhesive itself is subjected to rotation and/or vibration and the front end of the hotmelt adhesive is pressed onto the substrate to be coated, so that mechanical heat-generating friction is produced by the rotational and/or vibrational movement, resulting in melting of the front end of the hotmelt adhesive and its application to the substrate. A device such as this is extremely easy to operate and the hotmelt adhesive can readily be applied and distributed.

In one advantageous embodiment, the rotatable and/or vibratable element is connected to a rotation- or vibration-generating drive located inside the housing. Such drives are well-known and readily available and may therefore be used without difficulty for the device according to the invention.

In a particularly preferred embodiment, the rotation and/or vibration-generating drive is an electrical rotation- and/or vibration-generating drive. Basically, other, for example pneumatic or hydraulic, rotation- and/or vibration-generating drives may also be used. In an alternative embodiment, the actual rotation- or vibration-generating drive may also be arranged outside the device, in which case the rotation or vibration has to be suitably transmitted (for example via a drive shaft) from the drive to the rotatable and/or vibratable element located inside the housing.

Where the rotation- and/or vibration-generating drive is an electrical rotation- and/or vibration-generating drive integrated into the housing, a particularly preferred embodiment is characterized in that the electrical drive is connected to a power supply integrated into the housing, for example formed by accumulators or batteries. In this embodiment, the device is completely independent of any power sockets and is therefore easy to use anywhere.

To solve the problem stated above, the present invention also provides a method for applying a solid substance capable of application by heating, more particularly a hotmelt adhesive, to a substrate, the solid substrate being melted at its front end and applied in molten form to the substrate, characterized in that the front end of the solid substrate is subjected to rotation and/or vibration and pressed onto the substrate.

A hotmelt adhesive which is characterized in that it can be activated by internal or external friction, as described in EP 96/02194 to which reference is expressly made, is particularly suitable for the device according to the invention.

The friction should be of such magnitude that, with static friction, a film thickness of 2 to 200 μm and more particularly 10 to 100 μm is obtained by a single coating of the substrate with the adhesive at a speed of 1 to 500 cm/sec. and preferably 2 to 100 cm/sec. under a pressure of 1 kPa to 10 MPa, preferably 5 kPa to 5 MPa and more particularly 10 kPa to 10 MPa. These values are based on normal conditions (20° C./50% relative air humidity) and on paper of the following quality: 5015 Spezial Copier (manufacturer: Soennecken). The following working hypothesis was applied:

The crystalline regions are converted into an amorphous form by the mechanical effect of the friction. This amorphous form produces the tackiness. As long as the adhesive does not recrystallize, it remains tacky. After recrystallization, the adhesive loses its tackiness and acquires its ultimate strength.

This particularly suitable adhesive consists of 25 to 100% by weight, more particularly 30 to 99% by weight and preferably 60 to 98% by weight of at least one binder and 0 to 75% by weight, more particularly 0.1 to 70% by weight and preferably 0.5 to 40% by weight of additives. The binder is also the shaping substance. The principal function of the additives is to influence crystallization, tackiness and rub-off behavior. In addition, however, they may also perform the usual functions, i.e. stabilization, preservation, coloring, etc.

Besides the described adhesive, other hotmelt adhesives may also be used, particularly when they meet the above-mentioned requirements in regard to crystallization temperature, degree of crystallization and crystallization rate.

The invention is described in more detail in the following with reference to the accompanying drawing which is a highly schematized illustration of the device according to the invention.

The device according to the invention as shown in the drawing is intended to apply a solid substance capable of application by heating to a substrate. The solid substance is preferably a thermoplastic adhesive, for example a low-melt or hot-melt adhesive with melting temperatures of 60-80° C. and 180-220° C., respectively.

The device comprises a housing 1 in which a power supply (not shown), for example in the form of accumulators or batteries, is preferably integrated. To this end, the housing 1 is designed to be opened and closed at a suitable place.

Projecting from the front end of the housing 1 is a tubular holder 3 into which the hotmelt adhesive to be applied is introduced in the form of a solid hotmelt adhesive stick or rod 4. The tubular holder 3 is preferably designed so that, in the operational position of the device, the hotmelt adhesive 4 always projects some way frontward from the holder 3, as shown in the drawing. This can be achieved in different ways, preferably with a device which presses the solid adhesive against the front outlet opening by means of a spring located at the rear end. Since the diameter of the outlet opening is smaller than the diameter of the solid adhesive, the adhesive is only pushed out when the softening temperature has been reached at the front end of the otherwise solid adhesive.

Now, it is essential to the device according to the invention that the tubular holder 3 is connected to a rotatable and/or vibratable element 2 located in the housing 1, i.e. is inserted into this element 2 in the embodiment illustrated. The element 2 is connected to a rotation- and/or vibration-generating drive (not shown) which is preferably accommodated in the housing 1. The rotation- and/or vibration-generating drive is preferably electrical and is connected to the power supply integrated into the housing 1.

By actuation of the rotation- and/or vibration-generating drive, the element 2 is subjected to a rotating or vibrating motion or to a combined rotating/vibrating motion. This motion is transmitted to the holder 3 fixedly connected to the element 2 and hence to the hotmelt adhesive 4. With the tip of the adhesive stick rotating and/or vibrating, the device is then pressed onto the substrate to be coated with adhesive so that heat-generating mechanical friction is produced by the movement of the adhesive tip relative to the substrate. The heat thus generated melts the adhesive tip which can thus be readily applied to the substrate and distributed.

As can be seen, the device is immediately ready for operation. There are no heating times or the like to limit the readiness of the device for operation.

The invention is not of course confined to the embodiment illustrated by way of example in the drawing. Other embodiments are possible without departing from the basic concept. Thus, the rotation- and/or vibration-generating drive could even be hydraulic or pneumatic. In addition, the rotation- and/or vibration-generating drive need not be integrated into the housing 1 and could be externally located, in which case a suitable connection to the device (for example in the form of a drive shaft) would have to be established.

1. A device for applying a solid substance capable of application by heating, said device comprising a housing with a holder for the solid substance that is open to the outside, wherein the holder for the solid substance is connected to a rotatable or vibratable element located in the housing.

2. The device of claim 1, wherein the rotatable or vibratable element connects to a rotation- or vibration-generating drive located in the housing.

3. The device of claim 2, wherein the rotation- or vibration-generating drive is electric.

4. The device of claim 3, wherein the electric rotation- or vibration-generating drive connects to a power supply integrated into the housing.

5. (cancelled)

6. The device of claim 1, wherein the solid substance capable of application by heating comprises a hot-melt adhesive.

7. A method of applying a solid substance capable of application by heating to a substrate, comprising the steps of subjecting the substance to a rotating or vibrating motion and pressing the rotating or vibrating substance to a substrate surface, whereby the substance in contact with the substrate melts and applies to the substrate.

8. The method of claim 7, wherein the solid substance capable of application by heating comprises a hot-melt adhesive.
